(19) United States
(12) Patent Application Publication
(10) Pub. No.: US 2025/0288837 A1
(43) Pub. Date: Sep. 18, 2025

(54) FIREFIGHTING MIST TURBINE, FIREFIGHTING MIST TURBINE ASSEMBLY AND METHOD FOR THE APPLICATION OF FIREFIGHTING AGENT

(71) Applicants: Minimax Viking Research & Development GmbH, Bad Oldesloe (DE); EmiControls GmbH, Bolzano/Bozen (IT)

(72) Inventors: Holger MARTENS; Georg BAUMANN, Lübeck (DE); Stefan PFIEFFER; Thorsten GIESEKE, Großhandsdorf (DE)

(21) Appl. No.: 18/838,198

(22) PCT Filed: Feb. 14, 2023
(86) PCT No.: PCT/EP2023/053610

§ 371 Date: Mar. 27, 2025

(30) Foreign Application Priority Data
Feb. 14, 2022 (EP) 22156648.2

(51) Int. Cl. A62C 31/07; B05B 1/10; B05B 7/00; B05B 7/24

(52) U.S. Cl. CPC A62C 31/07; B05B 1/10; B05B 7/0075; B05B 7/2491

(57) ABSTRACT

The invention relates to a firefighting mist cannon (1) having a firefighting agent connection (20) for connecting to a pressurized firefighting agent supply, a housing (7) that can be pivoted about a vertical axis (Z) and a horizontal axis (Y) relative to the firefighting agent connection (20) and having a first, inlet-side housing opening (19) and a second, outlet-side housing opening (22), a flow generator arranged in the housing (7), which is designed to provide an air flow (L) from the first housing opening (19) in the direction of the second housing opening (22), and a firefighting nozzle arrangement (25) associated to the second housing opening (22), fluidically connected to the firefighting agent connection (20) and designed to output firefighting agent in such a way that the firefighting agent is captured by the air flow (L). It is proposed for the firefighting nozzle arrangement (25) to have at least one central tube (27), which is arranged within the housing (7) and oriented in an output direction (W), and which is fluidically connected to a horizontally and vertically pivotable distributor device (37) by means of a supply line section (44), wherein the supply line section (44) is designed with a harmonic curvature.

The present invention relates to a firefighting mist cannon having a firefighting agent connection for connecting to a pressurized firefighting agent supply, a housing that can be pivoted about a vertical axis and a horizontal axis relative to the firefighting agent connection and having a first, inlet-side housing opening and a second, outlet-side housing opening, a flow generator arranged in the housing, which is designed to provide an air flow from the first housing opening in the direction of the second housing opening, and a firefighting nozzle arrangement associated to the second housing opening, fluidically connected to the firefighting agent connection and designed to output firefighting agent in such a way that the firefighting agent is captured by the air flow.

Firefighting mist cannons of the aforementioned type are known in general. With regard to the pivotability of their firefighting nozzle arrangement, they are similar to firefighting monitors, which are mounted, for example, to stationary firefighting systems or firefighting vehicles or police emergency vehicles, and which are able to apply large quantities of firefighting agents in a precisely defined direction, sometimes over great distances of well over 50 meters.

In this context, firefighting mist cannons are configured such that at least a portion of the firefighting agent output by the firefighting nozzle arrangement is atomized into a firefighting mist, thus improving the firefighting effect. Furthermore, when compared to conventional firefighting monitors, firefighting mist cannons have the additional feature of a flow generator, which captures the firefighting agent output via the firefighting nozzle arrangement by the air flow directed in the direction of the outlet and further expels it in the output direction of the housing, wherein a larger output range and, depending on the use case, a further atomization of the firefighting agent into a firefighting mist are achieved due to the capturing of the firefighting agent by the air flow, thus improving the firefighting effect.

Firefighting mist cannons of the initially mentioned type are also distributed as firefighting turbines even though, strictly speaking, the drive of the flow generator is not always accomplished by means of a turbine, but often by using flow generators such as fans, which are driven by motors, in particular electric motors.

Relevant parameters of the firefighting mist cannons of the initially mentioned type for practical use include the achievable output ranges of the applied firefighting agent and the operating pressures of the pressurized firefighting agent supply required for this. In order to reach large output ranges of more than 50, in particular more than 60 or 70 meters, known firefighting mist cannons require operating pressures of well over 12 bar, in particular more than 14 or even 16 bar. While such operating pressures may usually be provided reliably by a reasonable amount of additional work with stationary use cases of the firefighting mist cannon, this is a much bigger challenge for mobile use cases. For mobile use cases and such high operating pressures, firmly associated devices for firefighting agent supply, such as permanently connected firefighting agent pumps, are often particularly large and expensive, and non-firmly associated devices for firefighting agent supply, such as those provided by firefighting vehicles or in the form of portable pumps of fire brigades, are usually designed for performance just sufficient for the original use cases.

There is demand to improve the output range, i.e., the maximum application of firefighting agents, with respect to the pressure of the pressurized firefighting agent supply required for this.

Accordingly, the invention was based on the object of improving the performance in the application of firefighting agents in general. In particular, the object was to improve a firefighting agent cannon of the initially mentioned type in such a way that the drawbacks detected in the prior art are overcome as efficiently as possible. In particular, the invention was based on the object of improving a firefighting agent cannon in such a way that the minimum pressure of the pressurized firefighting agent supply required for operation may be reduced without reducing the achievable output range of the firefighting agent and/or to reach a larger output range at an unchanged pressure.

The invention achieves the object on which it is based by proposing a firefighting mist cannon having the features of claim 1. In particular, the invention proposes for the firefighting nozzle arrangement to have at least one central tube, which is arranged within the housing and oriented in an output direction, and which is fluidically connected to a horizontally and vertically pivotable distributor device by means of a supply line section, wherein the supply line section is designed with a harmonic curvature. According to the invention, a harmonic curvature means that the supply line section does not have any changes in direction exceeding a predetermined critical angle of change and/or falling below a predetermined critical radius of curvature. Thus, the curvature preferably has either no angular changes in direction and no curves or it has a number of angular changes in direction, but each below an angle of change of 45°, preferably 30°, particularly preferred 15°, and/or it has a number of curves, but each exceeding a radius of curvature of 0.5 times their nominal size, preferably exceeding 0.7 times their nominal size, and particularly preferred not falling below 1.0 times their nominal size.

In other words, a curvature is considered to be harmonic when it has no changes in direction or at least has only small changes in direction within the above parameter range. Preferably the only present changes in direction are curves having the radii defined above. The radii may be constant along a curvature, but they may also change progressively or degressively.

Thus, the supply line section may be formed straight throughout. It may be formed entirely of angular or curved segments. Furthermore, it may be formed of straight segments and angular or curved segments as long as the angles and/or curves are within the above parameter ranges.

The harmonically designed curvature of the supply line section guarantees that the firefighting agent may flow better along the entire path between the distributor device and the central tube, wherein pressure losses due to abrupt deflections, which would otherwise cause a reduction of dynamic pressure, may be avoided. Examples from the prior art leading to inharmonic curvatures of supply line sections include T-connectors.

The inventors found that an unexpectedly positive impact on the application efficiency of the firefighting mist cannon may be obtained simply by eliminating such unfavorable geometries. With a harmonized curvature of the supply line section, the pressure loss inevitably resulting from conveying the firefighting agent from the firefighting agent connection to the central tube is minimized more than expected.

In an advantageous further development of the invention, the supply line section is formed of straight pipe sections and/or arcuately curved pipe sections. In other words, the supply line section consists exclusively of straight or arcuately curved pipe sections, providing a way of implementing the harmonic curvature which is easy to lay out and manufacture in terms of construction.

According to the invention, the term “pipe” means a line having a substantially cylindrical internal cross section, which is preferably made of metal, but may also be made of non-metal materials adapted to the predetermined pressure range, such as plastics, composites or a material mixture of different materials.

In a further preferred embodiment, the supply line section is disposed inside the housing. It has been found that moving the supply line section into the inside of the housing of the firefighting mist cannon results in a considerably lower impairment of the firefighting agent output from the firefighting mist cannon than expected even though the supply line section inevitably impairs the free cross section through which the air flow generated by the flow generator is conveyed. In this way, this embodiment allows a significant shortening of the overall length of the supply line section from the distributor device to the central tube and, consequently, a reduction of friction losses. In doing so, a possible measurable impairment of the air flow within the housing will only be relevant—if at all—to a very limited extent.

In a further preferred embodiment, the supply line section has a first internal line cross section at its inlet-side end and a second internal line cross section at its outlet-side end. The second internal line cross section is larger than the first internal line cross section or equal to the first internal line cross section.

Between the two ends, the supply line section preferably has a cross-sectional extension that remains larger than or equal to the first internal line cross section throughout. In other words, the supply line section is preferably formed without any cross-sectional constrictions, so flow resistances and the occurrence of turbulences based on possible cross-sectional changes may be avoided in most cases. This also has a surprisingly high positive effect on the reduction of pressure losses in the transfer path between the firefighting agent connection and the central tube.

It has been found that a local widening of the internal cross section in the supply line section, which would of course result in another cross-sectional taper at its local end, is not harmful for the overall application efficiency of the firefighting mist cannon. As long as the cross section at the outlet of the supply line section is equal to or larger than the cross section at the inlet and is not smaller than the cross section at the inlet anywhere, a favorable pressure profile according to the invention is guaranteed.

In a further preferred embodiment, the supply line section has two fluidically parallel pipe segments and/or pipe segment assemblies at its inlet side, which are connected to the distributor device and converge into one another in an arcuate shape and in a common direction, in particular in the output direction, at its outlet side. It has been found that dividing the firefighting agent flow into two partial flows in the distributor device, together with the converging into one another at the central tube as defined above, constitutes a very efficient fluid guide for the use case. The division of the fluid flow in the distributor device is advantageous for the mechanical configuration of the distributor device, on the one hand, and of the supply line section, on the other hand, as supporting the central tube and the supply line section is simplified in terms of construction. Due to the converging into one another, the two partial flows of the firefighting agent are guided into one another in a favorable flow, and collisions between the partial flows are avoided as much as possible. In this way, turbulences of the firefighting agent flow within the supply line to the central tube are less likely to occur and cavitations are minimized or, at best, avoided. Pressure fluctuations will be much less pronounced, if at all present, and consequently pressure losses will be lower. In addition, the division of the supply line section into multiple parallel pipe segments and/or pipe segment assemblies, as defined above, will not lead to a negative impact on the overall output behavior to be expected at a first glance, even though this division of the supply line section into pipe segments is also disposed within the housing and, thus, within the air flow generated by the flow generator.

In a further preferred embodiment, the two fluidically parallel pipe segments and/or pipe segment assemblies of the supply line section have the same line length. Further preferably, these pipe segments and/or pipe segment assemblies are formed in identical shapes, and are formed, particularly preferred, to be symmetrical to one another. The symmetry is preferably present in a plane extending in the output direction, in particular a vertical plane.

In a further preferred embodiment, the supply line section has, preferably at its outlet side, a shut-off device configured to be moved reciprocally between a shut-off position and a release position, wherein the shut-off device closes the supply line section in a fluid-tight manner in the shut-off position and releases it in the release position. In the release position, the shut-off device has a passage cross section which is equal to or larger than the first internal line cross section of the supply line section. Preferably the shut-off device is designed as a ball valve. In contrast to other shut-off devices, in particular in contrast to diaphragm valves, this allows shutting off and releasing the fluid flow through the central tube without causing a constriction of the internal line cross section of the supply line section. Other valves create constrictions of 10% or more, often even 30% or more, with respect to the line cross section upstream of the valve and downstream of the valve, on a regular basis, even in the fully open position, so use of the shut-off device as described above, in particular a ball valve, further contributes to minimizing pressure losses.

In addition, a shut-off device designed as a ball valve occupies little of the free cross section within the housing and thus causes only little impairment of the air flow generated by the flow generator.

In a further preferred embodiment, the shut-off device is controlled fluidically, preferably by means of a dedicated fluid circuit. Preferably the dedicated fluid circuit is a hydraulic control circuit or a pneumatic control circuit. In case of a hydraulic fluid circuit this means a self-contained fluid circuit independent from the firefighting agent. For example, using water-hydraulic controls of shut-off devices designed as diaphragm valves is known from the prior art, wherein the control circuit was fluidically connected to the pressurized firefighting agent connection. Here it was possible to omit the dedicated fluid circuit and instead use the firefighting agent flow to control the shut-off device. However, this meant that, in order to achieve the control pressure and thus the correct operation of the shut-off devices, the firefighting agent supply always had to reach the required pressure as well. On the other hand, the firefighting agent supply always had to be conveyed with a pressure high enough to be able to control the shut-off devices. Controlling the shut-off device independently from the pressure in the firefighting agent flow improves both the operational behavior of the firefighting cannon in terms of conveying the firefighting agent and the control of the shut-off devices since both units may be controlled by their respective ideal control pressures. In addition, this makes the overall system less susceptible to errors.

In a further preferred embodiment, a connection for coupling a first firefighting nozzle is associated to the central tube on its outlet side. In a first preferred variation, a steel pipe is provided as the firefighting nozzle. The steel pipe may be a hollow steel pipe or a combination steel pipe, for example, having an adjustment device configured to switch the output behavior of the steel pipe reciprocally between a first end position optimized for a maximum output range and a second end position configured for maximum spray distribution of the firefighting agent. In case a foaming additive is used in the firefighting agent, firefighting foam may also be formed in the intermediate positions and in the end position. Preferably the adjustment device is provided with an interface for external control, which interface may be an electric interface for wired or wireless remote transmission, for example.

In other words, the first firefighting nozzle has adjustment means for setting the spray pattern between a first, focused end position and a second, expanded end position, wherein the adjustment means are preferably controlled pneumatically, hydraulically or electrically. The focused end position is used, for example, when the firefighting mist cannon should reach a particularly large output range through the central tube or when the firefighting agent should be output against an object with particularly bundled kinetic energy. The expanded end position is used, for example, when areas should be protected from the spreading of a fire by using a highly diffuse spray pattern or when foam should be formed. The expanded end position can thus also be called a barrier position or a foam position. In preferred embodiments, the adjustment between the end positions is done in stepless fashion, wherein preferably the adjustment means are operatively connected to a programming logic, which may be controlled externally, wherein the programming logic is configured to control the adjustment means, as a function of a received adjusting command, to assume a position representative for the adjusting command. Foam may be formed to a certain extent in these positions as well.

In a further preferred embodiment, the firefighting nozzle arrangement has a nozzle ring, which extends circumferentially along the nozzle opening, preferably on the inside, wherein the nozzle ring has multiple, preferably third, firefighting nozzles disposed along a circumference of the nozzle ring, which in turn are configured to generate and output a firefighting agent spray mist such that the firefighting agent spray mist is captured by the generated air flow in the output direction.

In preferred embodiments, one, some or all of the firefighting nozzles are designed as cone nozzles. The cone nozzles may be hollow cone nozzles or full cone nozzles, wherein full cone nozzles are particularly preferred for use. Preferably each of the full cone nozzles used has a single outlet opening.

Preferably, with a pressure of 5 bar at the nozzle, the firefighting nozzles have a flow rate of 13 L/min or more, further preferably 15 L/min or more, further preferably 18 L/min or more, and particularly preferred 22 L/min or more.

Preferably, with a pressure of 10 bar at the nozzle, the firefighting nozzles have a flow rate of 18 L/min or more, further preferably 21 L/min or more, further preferably 25 L/min or more, and particularly preferred 32 L/min or more.

When designed as cone nozzles, the firefighting nozzles preferably have a spray cone angle in a range of 60° to 120°, preferably a spray cone angle of 90°.

Preferably the firefighting agent output by the nozzles of the nozzle ring is at least partially directed towards a central axis of the nozzle opening such that the capturing of the spray mist by the generated air flow is facilitated. The air flow generated by the flow generator provides for a larger output range of the spray mist, on the one hand, and for an additional further atomization, on the other hand. As far as “second” firefighting nozzles are mentioned above herein, this means that, on the one hand, the firefighting nozzles of the nozzle ring may be basically self-contained firefighting nozzles optimized for use on the nozzle ring, but, on the other hand, may also be identical to the second firefighting nozzles as described above. The second firefighting nozzles also provide for a forming of foam at the nozzle outlet when a foam additive is used.

In a further preferred embodiment, the nozzle ring is fluidically connected to the distributor device by means of a second supply line section, wherein according to the invention the second supply line section—like the first supply line section—is formed with a harmonic curvature. The formation of the supply line section preferably follows the same principles as already described above for the first supply line, so regarding the above definition of the harmonic curvature and the extension of the second supply line section, reference is made to the above explanations of the first supply line section to avoid repetition.

Preferably the second supply line section is also formed of straight and/or arcuately curved pipe sections.

Preferably the second supply line section has a first internal line cross section at its inlet-side end, a second internal line cross section at its outlet-side end, which is larger than or equal to the first internal line cross section, and a cross sectional extension between these two ends, which is larger than or equal to the first internal line cross section throughout.

In a further preferred embodiment, the second supply line section has, preferably at its outlet side, a shut-off device configured to be moved reciprocally between a shut-off position and a release position. In the shut-off position, the shut-off device closes the second supply line section in a fluid-tight manner and releases it in the release position, wherein in the release position, the shut-off device further preferably has a passage cross section which is equal to or larger than the first internal line cross section of the supply line section. The shut-off device for the second supply line section is preferably also designed as a ball valve and may further preferably be controlled externally, for example via a dedicated fluid circuit and/or via the same circuit as the shut-off device of the first supply line section. If the same fluid circuit is used, appropriate feedforward control lines and/or feedforward control valves are preferably provided.

In a further preferred embodiment, the housing is operatively connected to one or more fluidically actuated lifting cylinders in order to perform the movement about the horizontal axis, wherein the lifting cylinder(s) is/are configured to reciprocally pivot the housing between an upwardly inclined end position and a downwardly inclined end position, wherein preferably the lifting cylinders are oriented such that in the upwardly inclined end position they are retracted further than in the downwardly inclined end position, in particular fully retracted in the upwardly inclined end position and fully deployed in the downwardly inclined end position.

In the above, the invention has been described with reference to a firefighting mist cannon in a first aspect. In a second aspect, the invention further relates to a mobile firefighting mist cannon assembly having a transport frame, in particular a setting-down or roll-off frame having fastening means to temporarily arrange the transport frame on a loading space of a vehicle for transport purposes, and a firefighting mist cannon mounted to the transport frame, wherein the firefighting mist cannon is designed according to any of the preferred embodiments as described above.

Mobile firefighting mist cannon assemblies are already known from the prior art, proposing a firefighting mist cannon according to the initially mentioned type on a trailer, for example. However, the arrangement of the firefighting mist cannon on a transport frame greatly broadens the possible fields of application and in particular the transport possibilities, since the transport frame may be assembled in flexible fashion and made useful for a wide variety of different transport vehicles, which allows a much wider range of applications than just using a trailer. That being said, the transport frame is preferably formed in a 20-feet or 40-feet sea container format and/or prepared to be received on a truck. As a setting-down frame, the mobile firefighting mist cannon assembly preferably is designed to be handled by a crane, that is, it has one or more hook couplings to engage crane gear. Alternatively, the mobile firefighting mist cannon assembly preferably is designed with a transport frame of a roll-off container system, which preferably also has a hook coupling for temporary arrangement on the loading space of the aircraft.

In preferred further embodiments, the mobile firefighting mist cannon assembly has one, some or all of the following configurations:
a generator for generating electric power is installed on the transport frame and operatively connected to the firefighting mist cannon for power supply thereof, in particular for power supply of the flow generator;
a firefighting agent reservoir is installed on the transport frame, wherein preferably one or more connections for supplying firefighting agent to the reservoir are associated to the firefighting agent reservoir, further preferably on both sides laterally with respect to a longitudinal axis of the transport frame;
a pump device is installed on the transport frame, connected to the firefighting agent reservoir on its inlet side and to the firefighting agent connection of the firefighting mist cannon on its outlet side, and configured to supply pressurized firefighting agent to the firefighting mist cannon;
one or more connections for respective supply of pressurized firefighting agent to the firefighting mist cannon from an externally connectible pump device are disposed on the transport frame, further preferably on both sides laterally with respect to a longitudinal axis of the transport frame;
a dirt trap device is disposed on the transport frame, preferably upstream of the pump device, fluidically connected to the firefighting agent connection of the firefighting mist cannon, and configured to discharge dirt particles from the firefighting agent.

In the above, the invention has been described with reference to the firefighting mist cannon itself. In a further aspect, the invention relates to a method for the application of a firefighting agent, in particular for firefighting and/or cooling purposes.

The invention achieves the initially mentioned object of improved performance in the application of a firefighting agent with a firefighting nozzle arrangement having a central tube and a firefighting nozzle associated to the central tube by a method comprising the steps of:
providing a pressurized firefighting agent, conveying the pressurized firefighting agent to the firefighting nozzle, and applying the pressurized firefighting agent from the firefighting nozzle, wherein the conveying step is performed by passing the pressurized firefighting agent through a supply line section disposed adjacent to the central tube in the upstream direction and designed with a harmonic curvature.

For performing the method, preferred embodiments use a firefighting mist cannon having the supply line section designed with the features of the preferred embodiments as described above. A firefighting mist cannon or a firefighting mist cannon assembly according to one of the embodiments described above is used in particular.

The method according to the invention exploits the same advantages as the firefighting mist cannon and the firefighting mist cannon assembly according to the invention. Preferred embodiments of the firefighting mist cannon and the firefighting mist cannon assembly are preferred embodiments of the method as well, and vice versa, so in this regard reference is made to the above explanations to avoid repetition.

The invention is described in more detail by means of a preferred exemplary embodiment with reference to the attached figures below, wherein:

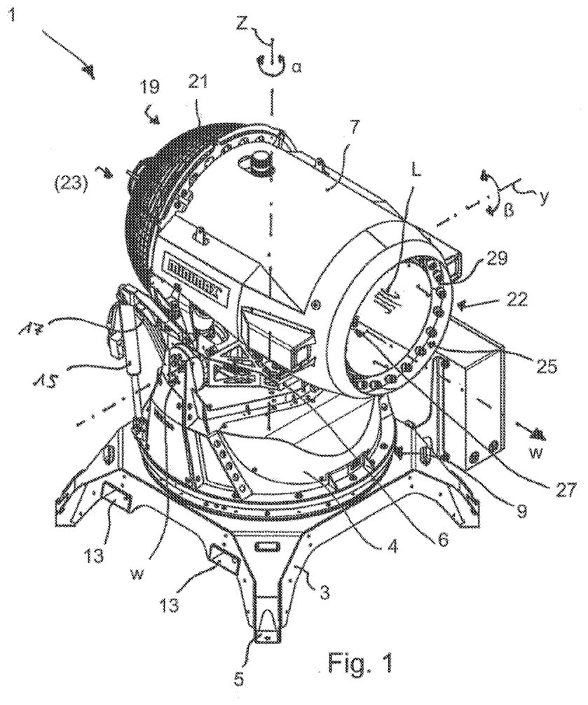

FIGS. 1-3 show different side views of a firefighting mist cannon according to a preferred exemplary embodiment,

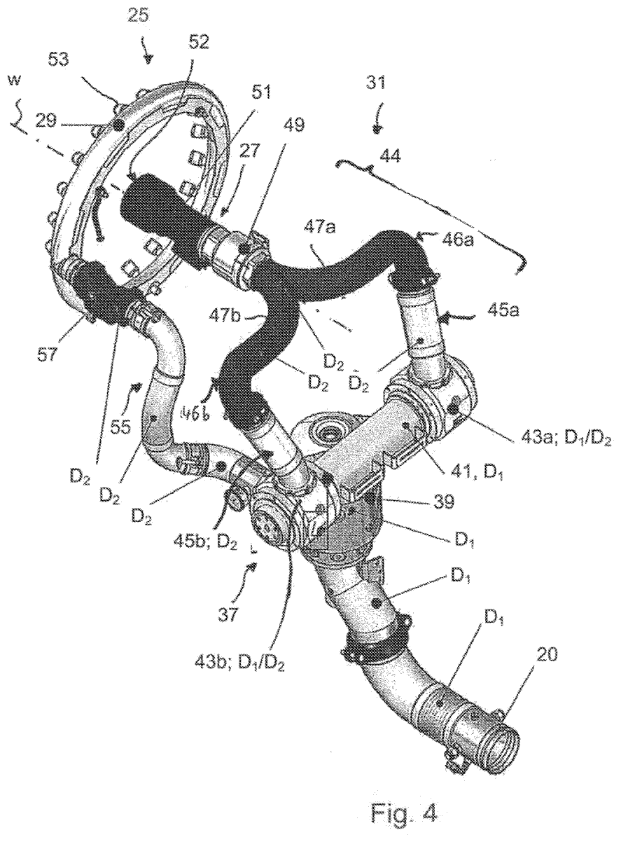

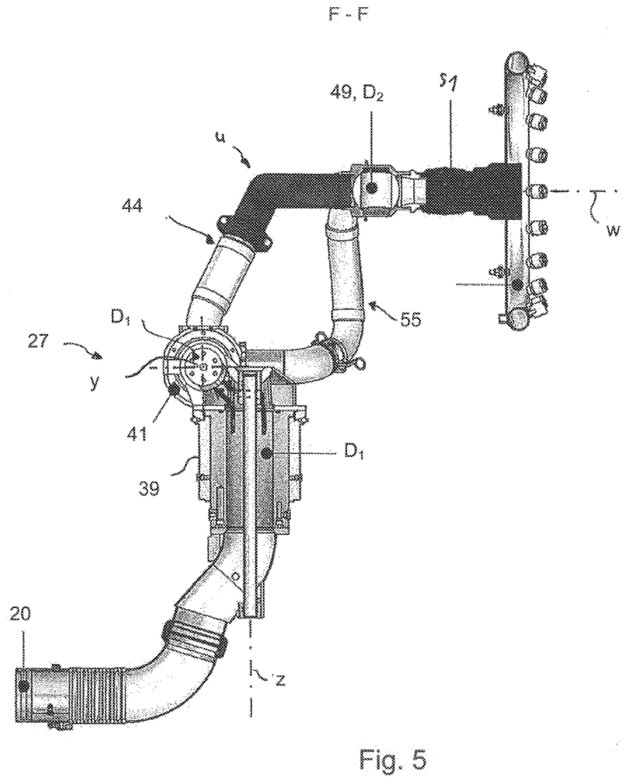

FIGS. 4, 5 show different side views of a fluid guide integrated into the firefighting mist cannon of FIGS. 1-3,

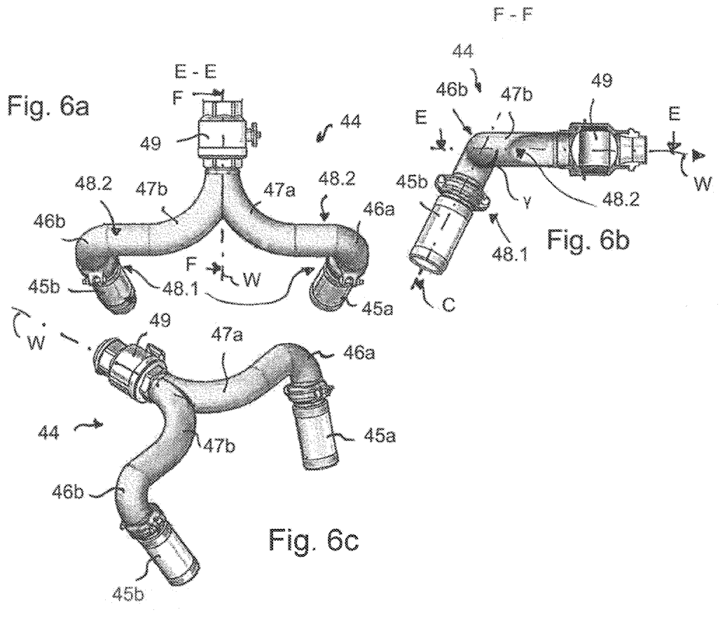

FIGS. 6a-6c show different three-dimensional views of a part of the fluid guide according to FIGS. 4-5,

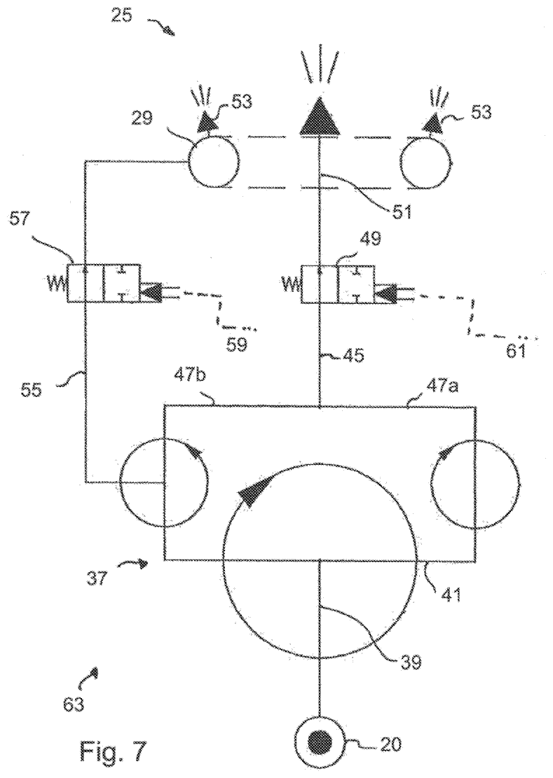

FIG. 7 shows a hydraulic flow diagram for the fluid guide according to FIGS. 4, 5,

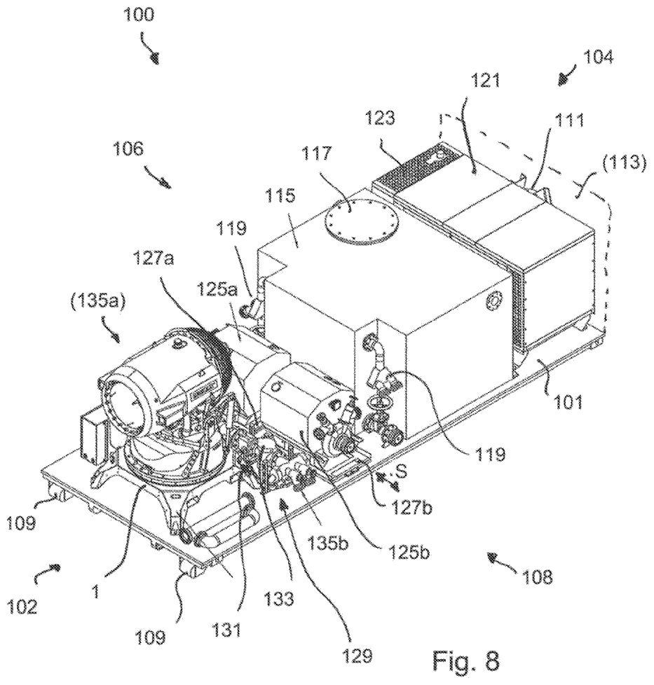

FIG. 8 shows a three-dimensional, schematic illustration of a mobile firefighting mist cannon assembly having a firefighting mist cannon according to the preferred exemplary embodiment,

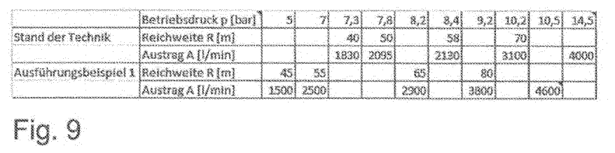

FIG. 9 shows an evaluation of the operation of the firefighting mist cannon according to FIGS. 1-8 as a table; and

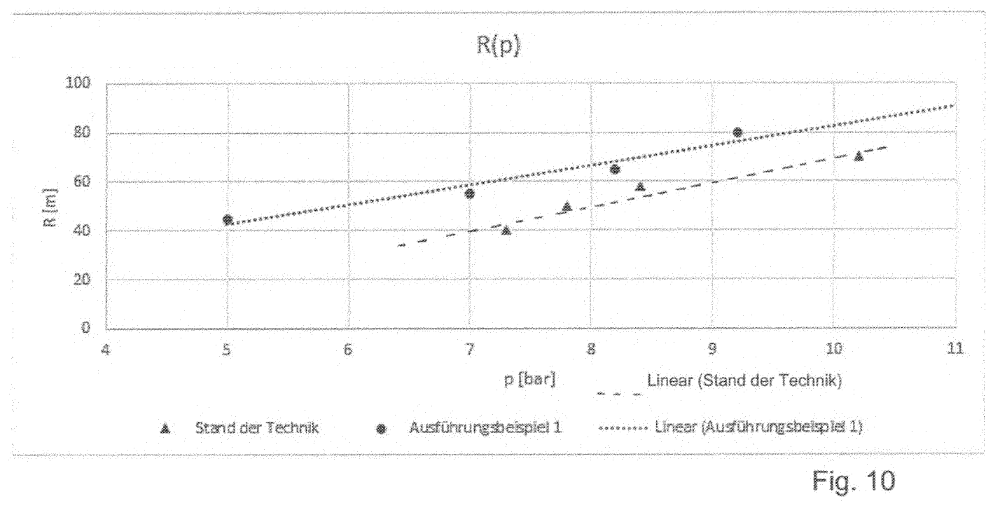

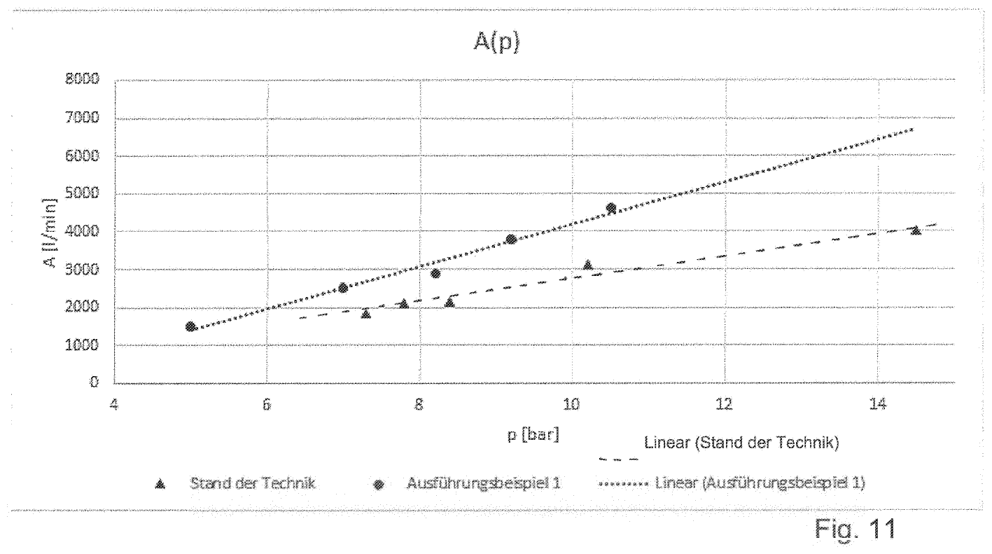

FIGS. 10, 11 show graphical plots of the table according to FIG. 9.

FIG. 1 illustrates a firefighting mist cannon 1 according to a preferred exemplary embodiment of the invention. The firefighting mist cannon 1 has a support structure 3 having multiple laterally protruding support feet 5. A housing base 4 is disposed on the support structure 3. The housing base 4 is configured to be pivoted about a vertical axis Z at an angle a. Preferably, starting from a neutral position called the 0° orientation, the value a is in a range of 180° to +180°, so a half-circular pivoting is possible on both sides, and the entire surroundings of the firefighting mist cannon may be covered. The drive of the pivoting about the vertical axis Z is preferably implemented by a hydraulic drive having a slew ring.

Above the housing base 4, the firefighting mist cannon 1 has a support structure 6 supported at the housing base 4 and configured to be pivoted about a horizontal axis Y in an angular range β, wherein the angular range β preferably spans an angular range of 45° or more, preferably 60° or more. Particularly preferred, starting from a horizontal position, the support structure 6 is pivotable for 15° or more in a first direction (downward direction) and pivotable for 30° or more, preferably 40° or more, in an opposite second direction (upward direction).

The housing base 4 is rotatably supported at the support structure 3, preferably by means of a rotary joint 9.

The support structure 6 is supported at the housing base 4, preferably by means of a rotary joint 11 as well.

On at least one side of the firefighting mist cannon 1, the support structure 3 has a number of forklift receptacles 13, which allow lifting and transporting the firefighting mist cannon.

For deflecting the support structure 6 with respect to the housing base 4, the firefighting mist cannon 1 has one or more lifting cylinders 15 operatively connected to a cantilever 17 of the support structure 6.

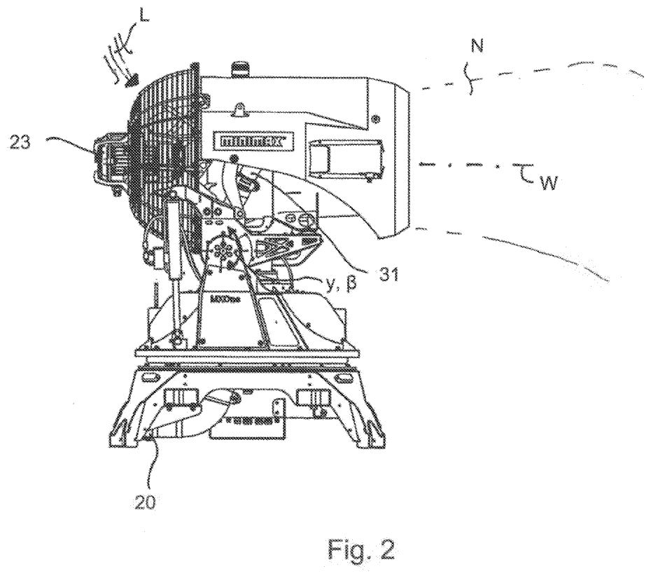

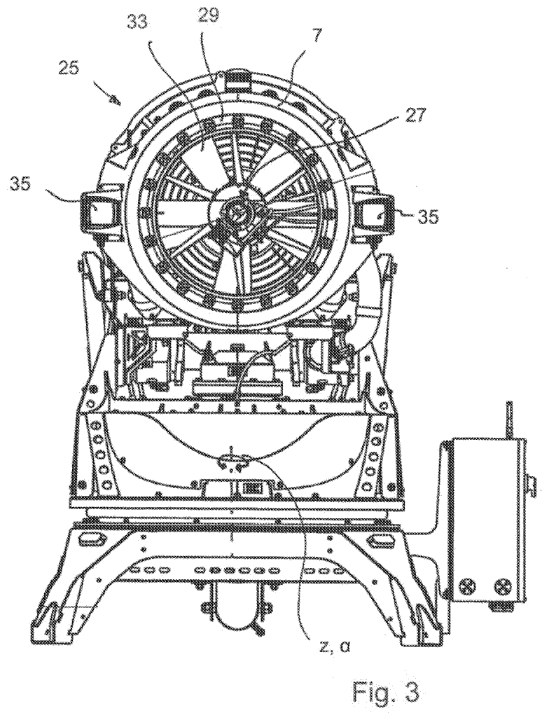

The firefighting mist cannon 1 has a housing 7 mounted on the support structure for the application of a firefighting agent. The housing 7 has a first housing opening 19 disposed at the rear and a second housing opening 22 disposed oppositely at the front. A protective grid 21 is disposed at the first housing opening 19. Also in the region of the first housing opening 19, the firefighting mist cannon 1 has a flow generator 23, cf. in particular FIGS. 2, 3. The flow generator 23 is configured to suck in air from the first housing opening 19 and to blow it out of the housing 7 in the direction of the second housing opening 22, thus providing an air flow L. In other words, the first housing opening 19 is an air inlet opening while the second housing opening 22 s an air outlet opening. However, the second housing opening 22 is not used to blow out air exclusively. In the region of the second housing opening 22 there is a firefighting nozzle arrangement 25, configured to output a firefighting agent such that the firefighting agent is captured by the air flow L.

The firefighting nozzle arrangement 25 has a central tube 27 disposed inside the housing 7, preferably at a central position within the flow channel for the air flow L. The central tube 27 is oriented in an output direction W and configured to output a firefighting agent in the output direction W. After leaving the central tube 27 the firefighting agent is output out of the second housing opening 23 and output on an output trajectory by the firefighting agent cannon 1, where it is captured by the air flow L after the firefighting agent leaves the central tube 27.

In addition, the firefighting nozzle arrangement 25 had a nozzle ring 29, which is additionally configured to output finely spayed firefighting agent, which is also captured by the air flow L to be output in the output direction W as a firefighting mist N, see FIG. 2.

The firefighting agent is supplied to the firefighting nozzle arrangement via a firefighting agent connection 20 shown in FIG. 2 through a flow path 31, see FIG. 2, to the central tube 27 and the nozzle ring 29.

As can be seen in FIG. 3, in particular, the flow generator 23 has a number of rotor blades 33 configured to generate the air flow L inside the housing 7 and to capture and accelerate the firefighting agent output by the central tube 27 and the nozzle ring 29.

Preferably one or more lamps 35, such as LED spotlights, are disposed at the exterior of the housing 7 of the firefighting mist cannon 1 to be able to illuminate the firefighting area in the output direction W.

The fluid guide is illustrated in more detail in FIGS. 4 and 5.

Starting from the firefighting agent connection 20, a pressurized firefighting agent in the flow path 31 first enters a horizontally and vertically pivotable distributor device 37 via several pipe segments having a first nominal width D₁. The distributor device 37 has a first, vertical section 39 with a rotary feedthrough pivotable about the vertical axis Z, which is functionally associated to the interface between the support structure 3 and the housing base 4, and a second, horizontal section 41 with a rotary feedthrough 43a, 43b pivotable about a horizontal axis and associated to the interface between the support structure 6 and the housing base 4. Preferably the distributor sections 39, 41 of the distributor device 37 also have the same first nominal width D₁ as the upstream part of the flow path 31.

Preferably the first nominal width D₁ is in a range of DN100 or more, further preferably in a range of DN 125 or more. Preferably a diameter transition from the first nominal width D₁ to a smaller second nominal width D₂ is formed in the region of the rotary feedthrough 43. Preferably the second nominal width D₂ is in a range of below DN100, preferably in a range of DN 80 or below.

A first supply line section 44 extends from the distributor device 37 to the central tube 27. The supply line section 44 is also illustrated in detail in FIGS. 6a, 6b and 6c from various points of view. The first supply line section 44 is formed of a sequence, i.e., a successive arrangement, of straight pipe segments 45a, 45b and arcuately curved pipe segments 46a, 46b and 47a, 47b, which guide the firefighting agent from the distributor device 37 to the central tube 27 with a harmonic curvature. Preferably a first shut-off device 49, particularly preferred a ball valve, is disposed upstream of the central tube 27, in particular adjacent thereto.

In both the straight pipe segments 45a, 45b and the arcuately curved pipe segments 46a, 46b, 447a, 47b, the pipe segments in the first supply line section 44 have at least the second nominal width D₂ throughout. Preferably the shut-off device 49 also has the passage nominal width D₂ in its open position. This guarantees that in the first supply line section 44, from the inlet-side end at the distributor device 37 to the outlet-side end at the central tube 27, at least the internal line cross section with the nominal width D₂ is provided throughout.

As may clearly be seen in FIGS. 4, 5 and 6a-6c, the two curved pipe segments 47a, 47b are formed symmetrical in the supply line section 44, adjacent to the shut-off device 49 in the upstream direction at its outlet side. Preferably the entire supply line section is formed of two symmetrical segment sequences and/or segment arrangements 45, 46, 47 (a and b), each connected to the distributor device 37, in particular to the horizontal distributor section 41. The outlet-side pipe segments 47a, 47b are in a common plane E and converge into one another arcuately and in a common direction, that is, preferably the output direction W.

In this way, the partial flows are guided together tangentially in the first supply line section 44. The division into two fluid flows provides for a better distribution of forces in the mechanical setup of the fluid guide of the flow path 31. Since the fluid is guided from the distributor line 37 to the central tube 27 as two partial flows, a comparably large free cross section remains within the housing 7 to guarantee a satisfactory flow of the air flow L.

The plane E is preferably oriented horizontally in a neutral position of the housing.

The pipe segments 45a, 45b protruding from the distributor device 37 are in a common plane C. The curved pipe segments 46a, 46b are oriented towards the plane C with their inlet-side ends 48.1, and towards the plane E with their outlet-side ends 48.2. Both planes C, E of the supply line section 44 span an angle γ with one another. The straight line at the intersection of the two planes C, E is preferably oriented orthogonally to the output direction W and/or is perpendicular to the plane F and/or is oriented parallel to the axis Y.

The segment arrangements 45-47 of the supply line section 44 are preferably mirror-symmetrical to a plane of symmetry F, which is orthogonal to the plane E. The axis characterizing the output direction W is, in particular, at the intersection of the planes E and F.

In the exemplary embodiment in FIGS. 4 and 5, a first firefighting nozzle 51 is connected to the central tube 27. The first firefighting nozzle 51 is preferably configured as a multi-purpose jet pipe and may be controlled externally to adjust the spray pattern. In this way, the spray pattern of the first firefighting nozzle 51 may be adjusted between a first position with maximum spray distribution effect and a second position with maximum output range effect, either in steps or stepless.

This means that, depending on the adjustment made at the firefighting nozzle 51, its firefighting nozzle opening 52 may output firefighting agent with either a maximum output range or a maximum spray distribution effect, i.e., a firefighting agent output behavior as diffuse as possible, or a mixed form of these two effects in intermediate positions.

The flow path 31 further has a second supply line section 55 connected to one of the two rotary feedthroughs 43, on the left-hand side in FIG. 4, and extending from the distributor device 37 through to the nozzle ring 29. The second supply line section 55 is also formed with a harmonic curvature and consists of straight and arcuately curved pipe segments. Further preferably, the pipe segments of the second supply line section 55 also have at least the second nominal width D₂ throughout. The harmonic extension of the two supply line sections 44, 55 in terms of diameter and curvature allows a particularly advantageous firefighting agent transport with low pressure loss and good output behavior.

A second shut-off device 57 is disposed at the second supply line section 55 on its outlet side, preferably also having the passage nominal width D₂. In the present exemplary embodiment of FIGS. 4 and 5, the second shut-off device 57 is formed as a diaphragm valve, but it is to be understood that, as an alternative to using the diaphragm valve, a ball valve may and should be used at this location just as in the first supply line section 44. The second supply line section 55 supplies firefighting fluid to the nozzle ring 29, and the firefighting fluid is output through a plurality of second firefighting nozzles 53 within the nozzle ring, which are preferably disposed in uniformly distributed manner along the circumference of the nozzle ring 29. The second firefighting nozzles 53 are preferably formed as spray mist nozzles of the type described in the general section, with reference being made to the above explanations to avoid repetition.

An output direction as mentioned above and below is to be understood as the orientation of the firefighting nozzle arrangement 25. Under the action of gravity and the action of wind, the firefighting agent will, of course, not spread in perfectly linear fashion after leaving its respective firefighting nozzle 51, 53, but will follow a trajectory that is deflected towards the ground by gravity and may additionally be impacted by wind in a horizontal and/or vertical direction.

As can further clearly be seen in FIG. 7, both the first shut-off device 49 and the second shut-off device 57 may be controlled externally. Preferably one or both of the shut-off devices 49, 57 are designed as fluidically controlled valves, particularly preferred as hydraulic valves. The first shut-off device 49 is connected to a control circuit via a control line 61, and the second shut-off device 57 is connected to the same or a fluid circuit of its own for control via a second control line 59. Particularly preferred, the fluid circuits for the control lines 59, 61 are isolated and independent from the pressurized firefighting agent to be controlled by a control pressure perfectly tailored to the shut-off devices 49, 57, which may be significantly different from the fluid pressure of the firefighting agent, on the one hand, and to avoid contamination of the flow path 31, on the other hand. As an alternative to using hydraulics as the control medium, pragmatical or electrical systems are just as conceivable as electro-pneumatic systems, for example.

While FIGS. 1 to 7 show exterior and interior views of the firefighting mist cannon 1 alone, FIG. 8 shows a further development of the exemplary embodiment becoming a mobile firefighting mist cannon assembly allowing transport of the firefighting mist cannon to different sites of use. For this purpose, the mobile firefighting mist cannon assembly 100 has a transport frame 101 of the roll-off container type, which extends from a first side 102 (rear side) to a second side 104 (front side), wherein the terms “rear” and “front” both refer to the transport direction of a vehicle traveling with this container.

The firefighting mist cannon 1 is installed in the region of the rear side 102 on the transport frame 101.

At the front side 104 of the transport frames 101, a hook coupling 111 is disposed for receiving and releasing the firefighting mist cannon assembly 100 on a transport vehicle and from a transport vehicle, respectively. Preferably the transport frame 101 has a front wall covering 113. The frame structure is set up as a flat-rack.

The mobile firefighting mist cannon assembly 100 has a firefighting agent reservoir 115 with a manway 117 at its top and having several connections 119 for supplying a firefighting agent to the firefighting agent reservoir 115 at a third (right-hand) frame side 108 (again referring to the direction of travel). Preferably one or more connections 119 are disposed at a fourth (left-hand in the direction of travel) frame side 106 as well.

The mobile firefighting mist cannon assembly 100 further has a generator 121 for generating electric power, preferably a diesel generator. The generator 121 supplies the required electric power for maintaining operation to the other components, in particular the firefighting mist cannon 1. The firefighting agent reservoir 115 preferably has a capacity of 5,000 liters or more, in particular 6,000 liters or more.

The length of the transport frame from the rear side 102 to the front side 104 is preferably in a range of 6 meters or more, preferably between 6 meters and 6.40 meters. The width from the left-hand frame side 106 to the right-hand frame side 108 is preferably in a range of 2.20 to 2.80 meters, particularly preferred 2.50 meters, and the height of the transport frame including all attachments is preferably in a range of 2 meters or below.

Adjacent to the generator 121, a control cabinet 123 is provided for connecting the electric components to the firefighting mist cannon in a signal transmission manner and for controlling the firefighting mist cannon assembly.

On both lateral frame sides 106, 108 the firefighting mist cannon assembly 100 has rail systems 127a, 127b, preferably in symmetrical arrangement with each of them movable in a pull-out direction S, for reversibly releasable mounting of pumps 125a, for example portable normal pressure pumps, i.e., portable firefighting agent pumps, as used by firefighters. The pumps 125a, 125b are used to supply a pressurized firefighting agent from the firefighting agent reservoir 115 to the firefighting mist cannon 1. Alternatively or additionally, one or more check valves 131 and/or dirt trap devices 133 for discharging solids from the firefighting agent are provided at the transport frame 111 as part of a pipe system 129.

Furthermore, the pipe system 129 has one or more firefighting agent connections 135a, 135b, preferably on both sides of the transport frame 101. The firefighting agent connections 135a, 135b are preferably configured to be connected to external pressure lines and/or to external pumps.

The pipe system 129 connects the pumps and/or firefighting agent connections 125, 135 to the firefighting mist cannon 1 and in particular to its firefighting agent connection 20 (see above figures).

Comparative tests were carried out to evaluate the performance of the firefighting mist cannon of the exemplary embodiment described above. The firefighting mist cannon according to the above figures was compared to a firefighting turbine of the prior art.

The exterior dimensions of the firefighting turbine of the prior art are substantially the same as those of the device of the above figures. The fluid guide from the firefighting agent connection to the distributor device is mainly identical. However, the supply between the distributor device and the central tube is accomplished through a supply line section having a non-harmonized curvature and a non-harmonized cross section. In the device of the prior art, the firefighting agent is conveyed through a number of 90° angles, an internal constriction and a number of curved pipe segments.

Water was used as the firefighting agent in the test. The devices were inclined about the axis Y, with their output directions W upwards by 25° from the horizontal positions.

The nozzle ring was locked in both devices and identical firefighting nozzles, both set to the full-jet end position, were attached to the respective central tubes.

The setup of the test was the same as known in general for testing the output behavior of sprinkler systems. Collectors for receiving the firefighting agent output were placed in predetermined distances from the devices and the pressure of the pumps used was controlled such that the firefighting agent output from the central tube 27 (with the first firefighting nozzle 51 set to the focused end position) hit the centers of the collectors. The pressure of the firefighting agent applied for this at the firefighting agent connection—that is, at the fluid entry of the devices—was recorded. The distance at which a full wetting by water was still possible was recorded as the range.

The table of FIG. 9 lists two test series. The first two columns plot the range R reached during application of the firefighting agent as meters and the firefighting agent output in liters per minute, both against the pressure p at the firefighting fluid connection (reference numeral 20 in the exemplary embodiment) of a firefighting turbine of the prior art. The two lower columns of the table in FIG. 9 give R and A depending on the pressure p for a firefighting mist cannon according to FIGS. 1 to 8.

With the device of the prior art, measurements were only possible at pressures of above 7 bar as the built-in shut-off devices did not switch at lower values. The values for the prior art in the rightmost column were not measured, but taken from the information provided by the manufacturer of the prior art system and deemed to be correct.

FIG. 10 visualizes the achieved range R depending on the pressure (p). FIG. 11 visualizes the quantity A of the firefighting agent output depending on the pressure p. In addition to the measurement points according to FIG. 9, linear trend curves are superimposed in each of FIGS. 10 and 11, showing a good approximation of linear behavior in the measured working range.

The range functions Rᵢ(p)=Aᵢ p+Bᵢ are approximated as follows:
(1) R₁(p)=S₁ p+T₁; for the exemplary embodiment of the invention, where S₁=8.0 (m/bar) and T₁=+2.5 m, and
(2) R₂(p)=S₂ p+T₂; for the device of the prior art, where S₂=9.6 (m/bar) and T₂=−27.1 m.

The output functions are approximated as follows:
(3) A₁(p)=B₁ p+G₁; for the exemplary embodiment of the invention; where B1=561 (L/(bar min)) and G₁=−1417 (L/min)
(4) A₂(p)=B₂ p+G₂; for the device of the prior art, where B₂=1302.9 (L/(bar min)) and G₂=—288.6 (L/min).

FIGS. 10 and 11 clearly show that in the measured range the performance of the firefighting mist cannon is consistently above the performance of the prior art in terms of both the achievable range and the quantity of the firefighting agent output.

It can be seen in FIG. 10 that with the firefighting mist cannon 1 a firefighting agent may be applied at a lower pressure when compared to the prior art. Furthermore, it can be seen that at equal pressures a considerably wider range is reached with the firefighting mist cannon of the invention.

It is evident that equal output quantities required lower pressure according to the invention than in the prior art. The maximum firefighting agent output is higher than with the prior art, even at considerably lower operating pressures.

### LIST OF REFERENCES

1 firefighting mist cannon
3 support structure
4 housing base
5 support foot
6 support structure
7 housing
9, 11 rotary joint
13 forklift receptacle
15 lifting cylinder
17 cantilever
19 first housing opening
20 firefighting agent connection
21 protective grid
22 second housing opening
23 flow generator
25 firefighting nozzle arrangement
27 central tube
29 nozzle ring
31 flow path
33 rotor blades
35 lamp
37 distributor device
39 vertical section
41 horizontal section
43 rotary feedthrough, horizontally pivotable
44 first supply line section
45a, b straight pipe segment
46a, b curved pipe segment
47a, b curved pipe segment
48.1 inlet side, pipe segment 46
48.1 outlet side, pipe segment 46
49 first shut-off device
51 first firefighting nozzle
52 firefighting nozzle opening, first firefighting nozzle
53 second firefighting nozzle
55 second supply line section
57 second shut-off device
59 control line, second shut-off device
61 control line, first shut-off device
100 mobile firefighting mist cannon assembly
101 transport frame
102 first side (rear)
104 second side (front)
106 fourth frame side (left)
108 third frame side (right)
111 hook coupling
113 front wall covering
115 firefighting agent reservoir
117 manway
119 connections, firefighting agent reservoir
121 generator
123 control cabinet
125a, 125b pumps
127a, 127b rail systems, pumps
129 pipe system
131 check valves
133 dirt trap device
135a, 135b firefighting agent connections
A firefighting agent output
C, E, F plane
L air flow
N firefighting mist
p pressure of firefighting agent
R range of firefighting agent
S pull-out direction, rail
W output direction
Y horizontal axis
Z vertical axis
D₁ first nominal width
D₂ second nominal width

1. A firefighting mist cannon, having
a firefighting agent connection for connecting to a pressurized firefighting agent supply,
a housing that can be pivoted about a vertical axis and a horizontal axis relative to the firefighting agent connection and having a first, inlet-side housing opening and a second, outlet-side housing opening,
a flow generator arranged in the housing, which is designed to provide an air flow from the first housing opening in the direction of the second housing opening, and
a firefighting nozzle arrangement associated to the second housing opening, fluidically connected to the firefighting agent connection and designed to output firefighting agent in such a way that the firefighting agent is captured by the air flow,
wherein the firefighting nozzle arrangement has at least one central tube, which is arranged within the housing and oriented in an output direction,
wherein the central tube is fluidically connected to a horizontally and vertically pivotable distributor device by a supply line section, wherein the supply line section is designed with a harmonic curvature.

2. The firefighting mist cannon according to claim 1, wherein the supply line section is formed of straight and/or arcuately curved pipe sections.

3. The firefighting mist cannon according to claim 1, wherein the supply line section is disposed inside the housing.

4. The firefighting mist cannon according to claim 1, wherein the supply line section has a first internal line cross section at its inlet-side end, a second internal line cross section at its outlet-side end, which is larger than or equal to the first internal line cross section, and a cross sectional extension between these two ends, which is larger than or equal to the first internal line cross section throughout.

5. The firefighting mist cannon according to claim 1, wherein the supply line section has two pipe segments or segment assemblies at its inlet side, which are connected to the distributor device and converge into one another in an arcuate shape and in a common direction, in particular in the output direction, at its outlet side,
wherein the pipe segments have a same line length, and further are formed in identical shapes to be symmetrical.

6. The firefighting mist cannon according to claim 4, wherein the supply line section has, at its outlet side, a shut-off device configured to be moved reciprocally between a shut-off position and a release position, to close the supply line section in a fluid-tight manner in the shut-off position and release it in the release position, wherein, in the release position, the shut-off device has a passage cross section which is equal to or larger than the first internal line cross section of the supply line section.

7. The firefighting mist cannon according to claim 1, wherein a connection for coupling a first firefighting nozzle is associated to the central tube on its outlet side, wherein the first firefighting nozzle has adjustment means for setting a spray pattern between a first, focused end position and a second, expanded end position, wherein the adjustment means are controlled pneumatically, hydraulically or electrically.

8. The firefighting mist cannon according to claim 1, wherein the firefighting nozzle arrangement has a nozzle ring, which extends circumferentially along the nozzle opening, wherein the nozzle ring has multiple, second, firefighting nozzles disposed along a circumference of the nozzle ring, which are configured to generate and output a firefighting agent spray mist such that the firefighting agent spray mist is captured by the generated air flow in the output direction.

9. The firefighting mist cannon according to claim 8, wherein the nozzle ring is fluidically and directly connected to the distributor device by a second supply line section, wherein the second supply line section is formed with a harmonic curvature.

10. The firefighting mist cannon according to claim 9, wherein the second supply line section is formed of straight and/or arcuately curved pipe sections.

11. The firefighting mist cannon according to claim 9, wherein the second supply line section has a first internal line cross section at its inlet-side end, a second internal line cross section at its outlet-side end, which is larger than or equal to the first internal line cross section, and a cross sectional extension between these two ends, which is larger than or equal to the first internal line cross section throughout.

12. The firefighting mist cannon according to claim 9, wherein the second supply line section has, at its outlet side, a shut-off device configured to be moved reciprocally between a shut-off position and a release position, to close the second supply line section in a fluid-tight manner in the shut-off position and release it in the release position, wherein, in the release position, the shut-off device has a passage cross section which is equal to or larger than the first internal line cross section of the supply line section.

13. The firefighting mist cannon according to claim 1, wherein the housing is operatively connected to one or more fluidically actuated lifting cylinders in order to perform the pivot about the horizontal axis and configured to reciprocally pivot the housing between an upwardly inclined end position and a downwardly inclined end position.

14. A mobile firefighting mist cannon assembly, having a transport frame comprising a setting-down or roll-off frame, and a firefighting mist cannon mounted to the transport frame,
wherein the firefighting mist cannon is designed according to claim 1.

15. A method for application of a firefighting agent from a firefighting nozzle arrangement having a central tube and a firefighting nozzle associated to the central tube, comprising:
providing a pressurized firefighting agent,
conveying the pressurized firefighting agent to the firefighting nozzle, and
applying the pressurized firefighting agent from the firefighting nozzle,
wherein the conveying the pressurized firefighting agent to the firefighting nozzle comprises:
passing the pressurized firefighting agent through a supply line section disposed adjacent to the central tube in an upstream direction and designed with a harmonic curvature.
